(19) United States
(12) Patent Application Publication
(10) Pub. No.: US 2009/0197537 A1
(43) Pub. Date: Aug. 6, 2009

(54) Enhancing voice communication between a group of users in a network

(75) Inventor: Kenneth Isaacs, Wiltshire (GB)

Correspondence Address: STAAS & HALSEY LLP, SUITE 700, 1201 NEW YORK AVENUE, N.W., WASHINGTON, DC, 20005, US

(73) Assignee: NOKIA SIEMENS NETWORKS GMBH & CO, KG, MUNICH (DE)

(21) Appl. No.: 11/990,946

(22) PCT Filed: Aug. 18, 2006
(86) PCT No.: PCT/GB2006/050245

§ 371 Date: Mar. 10, 2009

(30) Foreign Application Priority Data
Aug. 23, 2005 (GB) 0517165.7

(51) Int. Cl. H04B 15/00

(52) U.S. Cl. 455/63.1; 455/466

(57) ABSTRACT

Voice communication is enhanced between a group of users in a network by providing data for transmission to the group of users; adding to the data other information relating to a new active user; and transmitting the combined data and information in a single message to all other users in the group.

### CROSS REFERENCE TO RELATED APPLICATIONS

This application is based on and hereby claims priority to United Kingdom Application No. 0517165.7 filed on 23 Aug. 2005, the contents of which are hereby incorporated by reference.

### BACKGROUND

Described below is a method of enhancing voice communication between a group of users in a network, in particular for global system for mobile communication (GSM) based systems, such as GSM edge radio access network (GERAN).

GERAN includes a voice group service (VGCS) whereby multiple users can communicate. Whichever user has control of the uplink, blocks all other users from speaking. More recently, a change in the talker has been followed by an indication of who the party talking is. However, this enhancement requires additional signalling and there is a delay in providing the information to other members of the group. In addition, the identity information is provided by stealing frames from the voice channel, which can have an impact on voice quality for the call, under certain circumstances.

### SUMMARY

Accordingly, a method of enhancing voice communication between a group of users in a network provides data indicating a new active user; adds to the data other information relating to the new active user; and transmits the combined data and information to all other users in the group. Preferably, the information is an identifier of the new active user.

Small message service (SMS) text messaging could be used to provide the information, but preferably, the information is provided as a short message from the new active user.

Preferably, the information appears on a visual display of the other users.

Preferably, the network is a mobile communication network.

Although, various type of communication network could make use of the method, preferably, the mobile communication network is a global system for mobile communication network.

Preferably, the combined data and information is transmitted across a network to base station interface in an existing message.

Preferably, the network to base station interface is between a mobile switching center and a base station controller.

Preferably, the existing message is an uplink seized message.

Preferably, the data and information are transmitted across an air or wireless interface between a base station and the users, using an existing message.

Preferably, the data and information are contained within one radio block on the air (wireless) interface.

Preferably, the existing message on the air (wireless) interface is an uplink busy message.

Preferably, the mobile terminal is one of a mobile telephone, a personal digital assistant, or a personal computer.

Preferably, the identifier is a pre-allocated talker identifier.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram of a system for carrying out the method;

FIG. 2 illustrates known signalling information for a voice group call where the uplink access is issued in a cell where the parented BSS is connected to the Anchor MSC (MSC-A); and, FIG. 3 illustrates signalling information for a voice group call.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

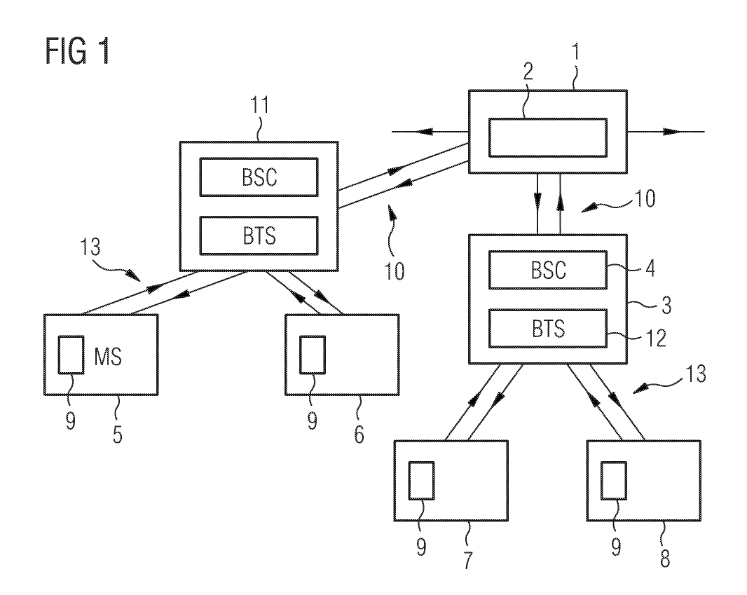

FIG. 1 illustrates a system in which the method is carried out. A network 1 communicates with mobile devices (MS) 5, 6, 7, 8 via different base stations according to the position of the mobile device. In this example a first base station sub-system (BSS) 3 is shown, with two MSs 7, 8 within range of this base station. A second BSS 11, communicates with two other MSs 5, 6. Two way communication is possible over an interface 10 between a mobile switching center (MSC) 2 in the network and a base station controller (BSC) 4 in each base station subsystem (BSS) 3, 11 The BSS is made up of the BSC 4 and a number of base station transceivers (BTS) 12. The BSC connects to the MSC and the BTS provides a radio interface to the MS. The base station controller 4 and mobile devices 7, 8 communicate via the BTS over an air (wireless) interface 13. Each mobile device is provided with a display 9.

Within the GERAN standardization process various enhancements for a voice group service (VGCS) have been proposed. A feature of these enhancements is provision of talker identity information in a message called VGCS additional information. This feature provides the identity of the talker to the current listeners of the voice group call, within the VGCS additional information message. As required by the standard, the VGCS additional information is sent on an air (wireless) interface on two logical channels, a fast associated control channel (FACCH) and a slow associated control channel (SACCH).

The VGCS additional information message is transmitted once on the downlink FACCH and periodically on the downlink SACCH, so that late joiners are provided with the identity of the current talker. The transmission of messages on the FACCH steals speech frames, thus these transmissions have an impact on voice quality.

In the voice group call service only one service subscriber has access to talk at any one time. In order for the network to control access to talk in the group call, the network transmits status messages on the downlink of the voice group channel to indicate whether the uplink is free or busy, using an UPLINK FREE and an UPLINK BUSY message respectively. If the uplink is busy, then the network may also indicate a priority of a call that is using the uplink. Both the UPLINK FREE and UPLINK BUSY messages are sent on the FACCH of the voice group channel. Thus, the transmission of the UPLINK BUSY has an impact on the voice quality of the speech received on the downlink of the voice group call channel.

Each UPLINK FREE and UPLINK BUSY message is contained within one radio block. Based on current performance, one radio block takes approximately 20 ms to transmit and contains 184 bits of information, or 23 bytes. In the voice group call service, the talker typically talks on average for 5 s. Thus, in this scenario, the transmission of the talker identity steals one block in 250, resulting in a frame erasure rate (FER) of 0.4%. If the UPLINK BUSY messages are transmitted every 5 s, as currently proposed in the standards, then this results in a combined FER of 0.8%, assuming that 2 blocks are stolen in every 250. However, in a situation where both the UPLINK BUSY message and the talker identity are sent within the first second of the talker starting to talk, then 2 blocks are stolen in 50, resulting in a FER exceeding 2%, which may not be acceptable. The standard also requires that the VGCS additional information is sent in a separate message on an A-interface from the mobile switching center to the base station controller. Sending of an UPLINK BUSY message by a BSS may be triggered as a result of the BSS receiving the following events, UPLINK ACCESS from the MS 5, 6, 7, 8 that originated the talker request, UPLINK SEIZED or UPLINK REJECT message from the MSC.

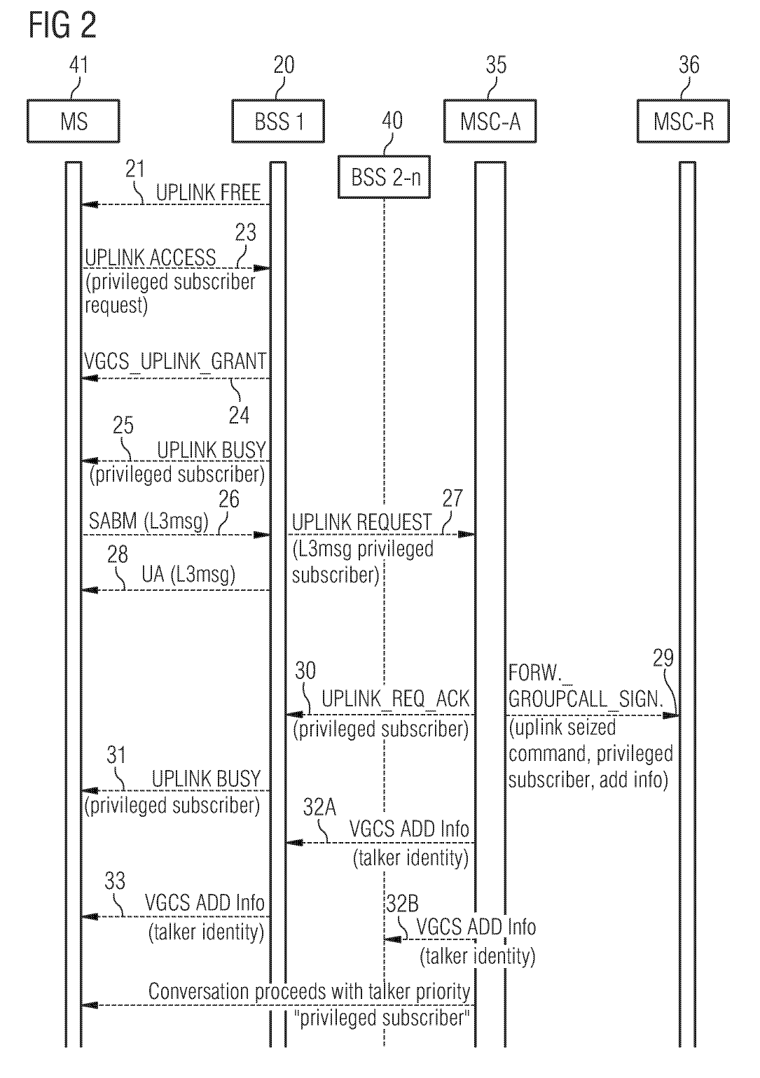

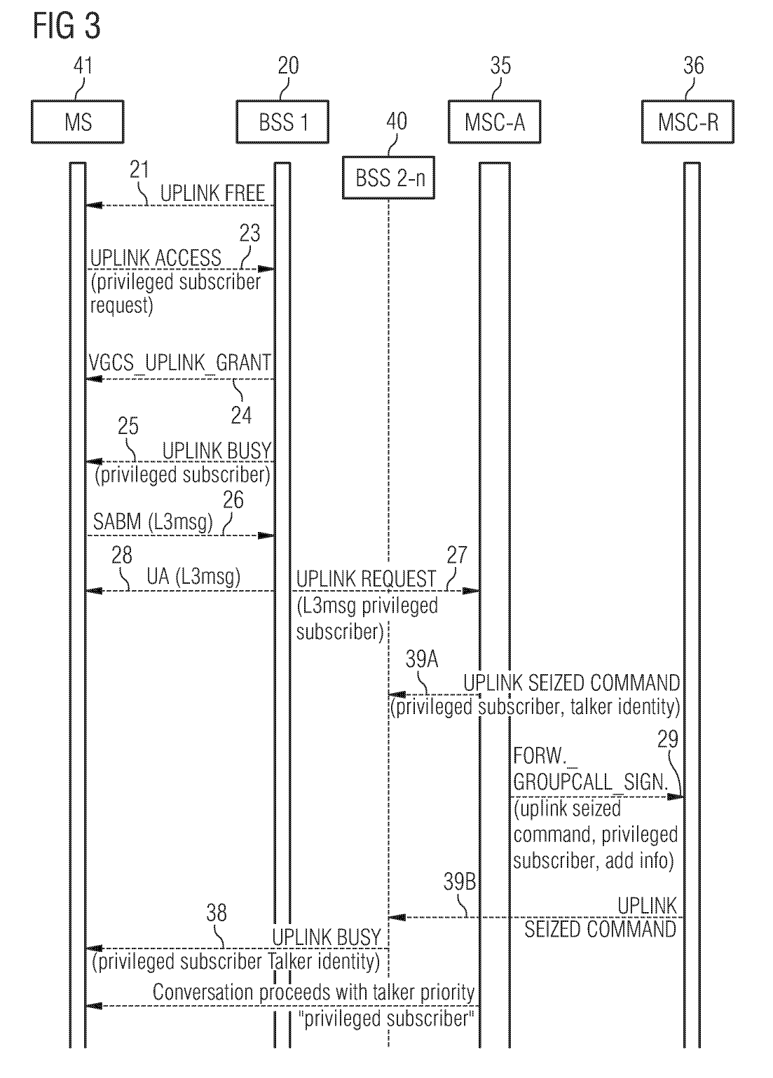

In FIG. 2, signalling information required for a voice group call uplink access in an anchor MSC (MSC-A) 35 with talker priority given to “privileged subscriber,” in accordance with the current standardized solution for the transmission of the talker information, is illustrated. A first base station sub-system (BSS1) 20 sends an UPLINK FREE message 21 to a mobile station (MS) 41. The MS sends an UPLINK ACCESS request 23 for privileged subscriber to the BSS 20 which sends a VGCS UPLINK GRANT message 24 and an UPLINK BUSY message 25, for privileged subscriber, back to the MS. Further, UPLINK BUSY messages are sent in each of the cells that the BSS parents that are in the group call area. A set asynchronous balanced mode (SABM) start-up command 26 is sent from the MS to the BSS including a layer 3 message (L3msg), such as a talker indication message which contains the mobile's identity. The BSS replies with an unnumbered acknowledgement (UA) 28.

An UPLINK REQUEST 27 is sent to MSC-A 35 which may reply with an UPLINK REQUEST ACKNOWLEDGE 30 to the BSC that originated the uplink request and an UPLINK SEIZED command to each of the remaining connected BSCs (not shown) that are in the group call area. The mobile device has sent its identifier, typically, IMSI, in the L3msg when establishing the signalling link on the air (wireless) interface. The L3msg is then included in the UPLINK REQUEST message that is sent by the BSC to the mobile switching center and the MSC-A checks a subscription for talker priority and retrieves additional information, such as a talker identifier from a visiting location register (not shown) which is what is sent to other members of the group. The sending of the Uplink Request 27 is delayed until the link on the air (wireless) interface is established. The link is established by a SABM/UA exchange, the purpose of which is so that the identity of the MS can be obtained and included in the Uplink Request that is sent to the MSC.

The additional information, when present, is then transmitted 32A by MSC-A to the first BSS 20 and also transmitted 32B to each other connected BSC in the group call area. The BSS then transmits this information as a separate VGCS ADD info message 33 on the air (wireless) interface.

MSC-A 35 sends a FORW_GROUP CALL_SIGN. message 29 to relay MSC (MSC-R) 36 including an uplink seized command, privileged subscriber data and the VGCS additional information The MSC-R then sends an UPLINK SEIZED message (not shown) for privileged subscriber, to each connected BSS 40 in the group call area. The BSS receiving the UPLINK SEIZED command then forwards an UPLINK BUSY message 31 to each cell that it parents in the group call area for transmission on the group call channels. Further information is provided in a separate VGCS_ADD_INFO message from the MSC-R to each connected BSC in the group call area. The BSC then transmits this information as a separate VGCS ADD info message on the air (wireless) interface. Typically, this information is talker identity, although it could equally be other information which the new talker wishes to share with all parties in the group, such as a location map for emergency services, or a geographical or person's name which might be difficult to understand and correctly record if given over air. The conversation within the group continues with the new active talker or privileged subscriber in control.

The need to provide information to the VGCS listeners regarding the identity of the current talker gives rise to a potentially unacceptable FER. To reduce the impact on the voice quality as a result of the transmission of the talker identity information on the air (wireless) interface, this information is transmitted within the UPLINK BUSY message. The UPLINK BUSY messages are periodically retransmitted on the downlink of the group channel. Sending of UPLINK BUSY messages may be triggered by the events as set out above. In order for the BSC to transmit the talker information in the UPLINK BUSY, either the MSC also includes the information in the UPLINK SEIZED, or the BSC delays sending the UPLINK BUSY until the VGCS additional information message is received from the MSC.

If this were done the other way around, with the UPLINK BUSY and VGCS additional information messages combined by including the contents of the UPLINK BUSY message within the VGCS additional information message, then legacy mobiles would be unable to receive an indication that the uplink is busy, which is not desirable.

If the talker identity information is too long to fit into the UPLINK BUSY message, then the talker identity information still has to be sent in a separate message.

Advantages include reduction in FER, i.e. better speech quality than in the case when the method described herein is not used, and the feature that the MS receives the identity of the talker earlier. It will be received as soon as the MS identifies that the uplink is in use. Additionally, if the VGCS additional information is not sent as a separate message on the A-interface (BSS to MSC) then less signalling messages would be sent on this interface, which although not of noticeable gain to the user, reduces the signalling load within the network.

FIG. 3 shows signalling information required for a voice group call uplink access in the anchor MSC with talker priority “privileged subscriber”, in which transmission of the VGCS additional information is merged into an existing message. The process involved is similar to those in the standardized mechanism of FIG. 2, up to the point of the UPLINK REQUEST 27. Instead of simply sending the UPLINK SEIZED message as before, the new UPLINK SEIZED message 39A now contains the talker identity which has been ascertained from a visiting location register and is sent on the A-interface between the MSC-A 35 and the BSC in each BSS 20, 40. Similarly, the UPLINK BUSY message 38 on the air (wireless) interface between the BSS 20 and MS 41 now contains the talker identity. Thus, the number of signalling messages required at this point is halved and the frame erasure rate is kept low, despite the addition of further information. The UPLINK SEIZED command may also be sent 39B from the MSC-R 36, as well as sent 39A from the MSC-A 35. This depends upon whether an MS in another part of the network with another MSC is connected to the voice group. Although the example of FIG. 3 shows only one MS connected to BSS1 20, this is to simply the diagram and in practice there are usually multiple MSs connected to any BSS 20,40.

If the talker identifier found in the visiting location register is very long, it might exceed the available number of bytes in the UPLINK BUSY message. However, the configuration of the identifier is under the control of the operator who can choose to configure the talker identifier for each member of that group, so that it is made to fit within the available space. The method can be adapted, so that if the, talker identity is not available when sending the original uplink management signalling message then rather than apply an unlimited delay to sending this message, then the talker identity may be sent in a separate VGCS Additional Info message.

The UPLINK BUSY message is repeated on the air (wireless) interface, typically every 5 seconds. This is so that late joiners to the group channel are told that the UPLINK is in use. The UPLINK BUSY message can indicate the priority of the active member. However, as the message is sent in UNACKNOWLEDGED mode, other listeners who did not receive the message may just hear somebody else talking.

The talker identity is typically sent as a short message to the mobile device of each other member of the voice group. Although this short message could be sent as a standard SMS message, this is not optimum, since a single radio block contains 23 bytes of which typically 6 are used for headers, leaving only 17 bytes for other messages such as an identifier of the active user. Using standard SMS for the short message, this also has headers which would use up more bytes, leaving very little space for the actual message, thus a short message which does not have any particular specified format is preferred.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-15. (canceled)

16. A method of enhancing voice communication between a group of users in a network, comprising:
providing data indicating a new active user;
adding to the data other information relating to the new active user to produce combined data and information; and
transmitting the combined data and information to all other users in the group.

17. A method according to claim 16, wherein the information includes an identifier of the new active user.

18. A method according to claim 17, wherein the network is a mobile communication network.

19. A method according to claim 18, wherein the information appears on a visual display of a device used by the other users.

20. A method according to claim 19, wherein said providing includes receiving the information as text from the new active user transmitted via a short message service.

21. A method according to claim 18, wherein the mobile communication network is a global system for mobile communication network.

22. A method according to claim 21, wherein said transmitting of the combined data and information includes transmitting across a network to a base station interface in an existing message.

23. A method according to claim 22, wherein the base station interface is between a mobile switching center and a base station controller.

24. A method according to claim 22, wherein the existing message is an uplink seized message.

25. A method according to claim 18, wherein said transmitting of the combined data and information is across a wireless interface between a base station and the users, using an existing message.

26. A method according to claim 25, wherein the data and information are contained within one radio block on the wireless interface.

27. A method according to claim 25, wherein the existing message on the wireless interface is an uplink busy message.

28. A method according to claim 27, wherein the device used by each of the users is one of a mobile telephone, a personal digital assistant and a personal computer.

29. A method according to 28, wherein the identifier is a pre-allocated talker identifier.

30. A mobile switching center providing enhanced voice communication between a group of users in a network, comprising:
at least one receiving unit receiving information relating to a new active user;
at least one processor programmed to add the information relating to the new active user to data indicating communication status to produce combined data and information; and
at least one transmission unit transmitting the combined data and information to all other users in the group.

31. A mobile switching center according to claim 30, wherein the information relating to the new active user is identifying information of the new active user.

32. A mobile switching center according to claim 31, wherein said at least one receiving unit receives the information from the new active user via a short message service text message.

33. A mobile switching center according to claim 32, wherein the mobile switching center is in a global system for mobile communication network and the data indicating communication status is an uplink busy message.

34. A mobile switching center according to claim 33, wherein the uplink busy message includes an identifier of a privileged subscriber.
